(19) United States
(12) Patent Application Publication
(10) Pub. No.: US 2010/0071917 A1
(43) Pub. Date: Mar. 25, 2010

(54) RESIDENTIAL FIRE PROTECTION SYSTEM AND METHOD

(76) Inventor: SHLOMO LALOUZ, San Diego, CA (US)

Correspondence Address: INTELLECTUAL PROPERTY BUSINESS CONSULTANTS, PLLC;Attn: Dr. Mario Sergio Golab, 1413 SANTA CRUZ AVE, CORAL GABLES, FL, 33134-2257, US

(21) Appl. No.: 12/235,604

(22) Filed: Sep. 23, 2008

(51) Int. Cl. A62C 37/10

(52) U.S. Cl. 169/60

(57) ABSTRACT

An outdoors residential fire-suppression system and method, employing very large water reservoirs, pumping means, one or more pipe circuits containing a plurality of batteries of fire extinguishing nozzles, and deployed around buildings on a property, that may be activated upon the automatic detection of a fire condition or manually as a preventive measure to create a fire barrier.

A zonal version of the system and method employs a plurality of outdoors residential fire-suppression system that can be activated individually or collectively to combat a wildfire or to prevent a wildfire from spreading. The zonal version of the system and method can be collectively operated by fire authorities by a plurality of means, including satellite and wireless transmissions.

The system can operate independent of any public energy supply and may be activated automatically or manually. Furthermore, the fire suppression system and method has the capability to issue audiovisual alarms, dial predefined telephone numbers, and report an impending fire condition.

### BACKGROUND OF THE INVENTION

1. Field of the Invention

This invention generally relates to a system and method to suppress dangerous fires around habitable structures and other premises threatened by wildfires and fires normally originating outside the premises. More particularly, this invention relates to a self contained system that can detect an impending or ranging fire or a source of high heat that may cause a fire, and direct fire suppressant material towards said source of fire to extinguish said fire. This invention also provides a method to control and generally lower the ignition point of combustible material located in proximity to the system such that wildfires may be prevented or extinguished in premises located where said fires may occur through the creation of an effective fireproof barrier.

2. Description of Related Prior Art

Wildfires have existed since time immemorial, and they may have been the initial source of fire that humans eventually used and domesticated for their own benefit.

Wildfires basically originate from two sources, nature and humans. While it is almost impossible to control nature's actions, humans have provided a number of controls for their management of fire which make wildfire spreading mostly avoidable or preventable. Yet, the number of fires attributed to nature's creation pales by comparison to the number originated by human errors or arson.

Currently, to combat a wildfire essentially large human and physical resources are utilized to prevent, confine, reduce, and suppress the spread of the fire. Most wildfires end when all combustible material is exhausted, thus firefighters work tirelessly to create wide enough barriers where wildfires cannot propagate. The areas that are used to limit the spread of the fire are either cleared of combustible material or covered with fire retardant material that essentially increases the combustible material's ignition point to a level that consumes most of the energy carried by the wildfire.

Wildfires have not been tamed or domesticated yet, quite the contrary, as humans encroach into wild habitats that have dry vegetation and other fire consumable materials, wildfires not only continue to occur but continue to toll material and often human life.

Recent climate changes have only exacerbated the problem of wildfires, especially those created by humans, which expand more uncontrollable and to wider areas that ever before. Until now, no effective solutions have been developed to tame, reduce, or limit the damage caused by wildfires.

In most cities, communal fire extinguishing systems are limited to providing a network of pressurized water carrying pipes that could be tapped by fire fighters in the event of a fire. Yet even this primitive fire extinguishing system is no available in wilderness areas, or even on the fringes of cities and counties. As human habitation moves into non-city maintained areas, fewer and fewer fire suppression means are available, if any.

The news showcase year after year how wildfires toll uncountable assets that are lost do to inadequate or non-existing residential or communal fire suppression systems.

Coincidental with the encroachment of into wilderness areas of residential buildings, is the high expense to develop access and level surfaces to build on such land. This high cost usually limits the land acquisition to people with above average financial means. Thus it is common that many of these new residential properties include a swimming pool. Yet, when a wildfire approaches these residences with swimming pools, the premises have no means to use the water stored in the pools to control an invading fire. It is visually and emotionally devastating to see a swimming pool intact while its adjacent residence is reduced to ashes.

Most managed forests have fire trails cleared to attempt to limit the expansion of wildfires. However, mountainous areas do not provide for easily accessible roads to drive machinery to create such fire clearings. The same large trees that provide shade or firewood provide the combustible material that nurtures a wildfire's rapid expansion.

When residential dwellings are built in mountainous areas, surrounded by highly combustible material, a suitable clearing must be maintained to provide a fire cushion of safety to the dwellings. However, often this is not the case, and after an initial clearing, neglect and time permits vegetation's advance to reduce or eliminate this fire safety cushion.

### BRIEF SUMMARY OF THE INVENTION

The inventive residential fire protection system and method consist of a combination of devices that enables the detection of a heat/fire source of sufficient caloric energy to generate or propagate a fire, the notification by various communication means to the appropriate fire authorities and owners, the activation of a fire suppression means to direct a fire suppressant to the detected fire or heat source, an energy source means to operate the detection means and fire suppression means, and a fire suppressant storage or source.

The system may be used automatically, upon the detection of a fire source, or manually to prevent the expansion of an occurring wildfire by presoaking the surrounding areas with fire suppressant material.

The invention provides for the use of a plurality of residential fire protection systems installed on various properties and activated independently or collectively by a central authority, such as firefighters. Selective activation of one or more residential fire protection systems may foe used strategically by firefighters to create one or more fire barriers or to douse an impending fire.

Each residential fire protection system may use one or more fire condition detectors deployed on a plurality of strategic sites on the premises to capture thermal readings that may indicate a fire or an abnormal heat concentration and high carbon dioxide levels, product of an impending fire. The fire condition detectors are capable of detecting and indicating where an abnormal heat source or fire is located and thus they can activate one or mere batteries of nozzles proximate to the fire condition.

The batteries of nozzles contain a plurality of nozzles positioned at a variety of angles such that a wide area of fire suppressant coverage is achieved. Some batteries of nozzles may contain nozzles that can be actively rotated to a plurality of angles to more accurately focus on a particular fire spot.

Fire condition detectors may activate a battery of nozzles until they run out of fire suppressant or the temperature reading falls bellow a temperature threshold, well know to people skilled in the art. Furthermore, the fire condition detectors may automatically connect and disconnect the suppression system when the thermal reading is below a predetermined level, or to allow for the replenishing of the fire suppressant, such as, for example and without limitation, swimming pool's water with city sourced water.

Simultaneous with the activation of a battery of nozzles, fire condition detectors may report their reading to a central processing unit that has a variety of duplex communication means and can report the reading to the dwelling owners and to appropriate fire authorities, and operate one or more audiovisual alarms. Furthermore, fire condition detectors may operate in a wired or wireless network and draw the energy to operate from photovoltaic cells or other means, well know the a person skilled in the art.

The inventive system allows for a variety of fire prevention and suppression strategies that may be used to control and prevent the expansion of a wildfire, even if said fire does not actually directly threaten the residence where the system is installed.

In addition to the fire condition detectors, a global strategy may be used by a fire department to create a fireproof barrier on the ground utilizing one or more premises equipped with the inventive fire protection system. An fire condition detector mounted on an unmanned aerial vehicle or airplane, a satellite with thermal reading capabilities, a network of strategically placed ground fire condition sensors, or similar equipment well known to a person skilled in the art may be used by the fire department to identify and determine a fire fighting strategy which may involve creating a fireproof barrier, such as one created by presoaking the area surrounding the residences equipped with the inventive system. In such case, the fire department may activate each individual fire protection system through a secret code and override the individual residential fire protection system fire condition detector's readings.

The fire condition detectors may be used to pinpoint the source of abnormal heat or fire and to activate one or more batteries of nozzles that direct the fire suppressant to the detected abnormal heat source or fire. Nozzles are positioned in a variety of angles, most commonly, but not limited to, from 0° to 180°, in fixed or variable positions and are used to direct the fire suppressant to a precise area or to a wide area of coverage. A battery of nozzles can be independently activated to focus the fire suppressant solely on the source of heat or fire or on a wider area, including over the premise's structures and dwellings, to presoak it and thus create a fire barrier.

The inventive system may use a variety of very large storage facilities of fire suppressant, such as swimming pool water, water from lakes, stream, and ocean, storage tanks or cistern holdings, and even public source water.

Preferably a non-intrusive or hidden pipe system conveys the fire suppressant from its storage location, such as, for example and without limitation a swimming pool, cistern, lake, water stream, ocean, public water source, or storage tank, to one or more battery of nozzles. The pipe system may be located anywhere, on or off the premises, but generally outside the buildings structure, including, but not limited to, the dwelling's roof, gutters, or fascia, the premises' garden, perimeter, fence, or any combination thereof, and may include one or more independent pipe circuits.

An energy source, such as, for example and without limitations, public electricity supply, electric batteries, solar and wind power electric generators, fuel operated electric generators, supply energy to one or more fire suppressant pumps that transport the fire suppressant from its holding storage or source, through the battery of nozzles, and into the heat or fire detected source.

### DRAWINGS

FIG. 1 is an embodiment of the invention's preferred deployment.

FIG. 2A is an embodiment of the inventive battery of nozzles.

FIG. 2B is a detail of the internal disposition of the inventive battery of nozzles at fixed angles.

FIG. 2C is a detail of the internal disposition of the inventive battery of nozzles at variable angles.

FIG. 3 is an embodiment of the invention's preferred deployment of multiple systems.

### DETAIL DESCRIPTION OF THE INVENTION

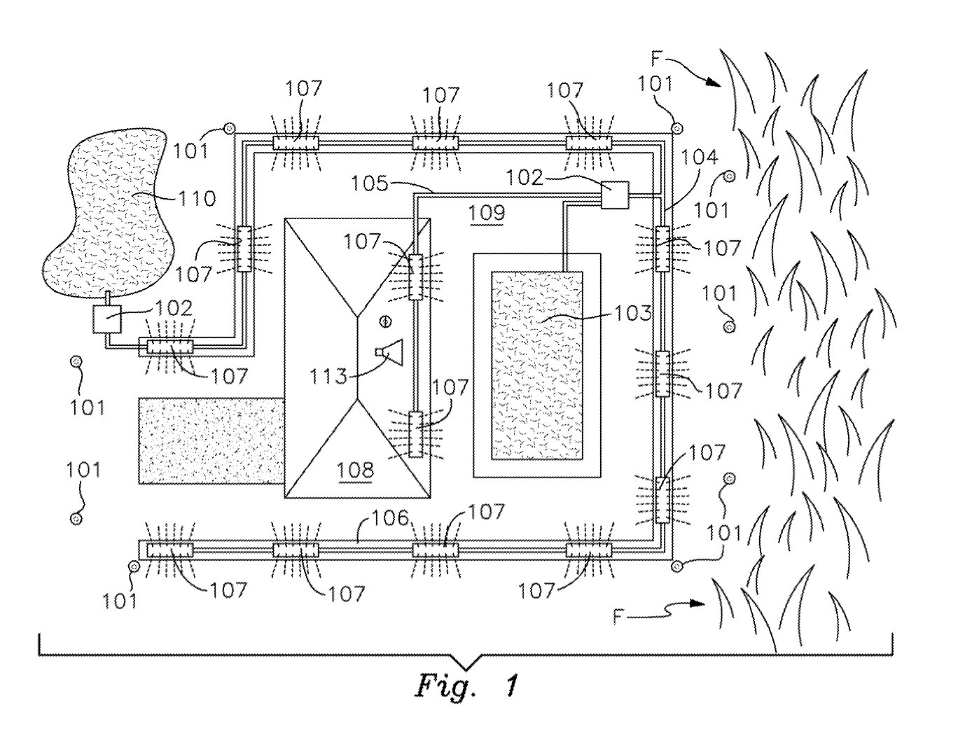

FIG. 1 depicts a top down view of a preferred embodiment of the invention.

Each residential fire protection system may use one or more fire condition detectors 101 deployed on a plurality of strategic locations in and around the premises. The fire condition detectors 101 may be, for example and without limitations, a variety of devices that are able to capture thermal and/or carbon dioxide readings that may indicate a fire, a fire smoke, or an abnormal heat concentration, and other factors distinctive of fire conditions well known to a person skilled in the art. The fire condition detectors 101 may be activated automatically dire to a fire condition reading, manually for testing, pre-dousing the inside or outside curtilage, the premise's buildings 108, or any other purpose, or remotely as later explained. The fire condition detectors 101 may be placed inside or outside the premises in such places well known to a person skilled in the art.

Upon activation of a fire condition detector 101, the residential fire protection system engages one or more pumps 102, which draw their energy from a variety of sources, including but not limited to an independent electrical storage device, an electricity generator, a mechanical motor, and others well known to a person skilled in the art.

A pump 102 siphons out a fire suppressant 103, which, for example and without limitation, may foe any material, in liquid, colloidal, solid, or gaseous form, which has the capabilities of suffocating and/or extinguishing a fire. Most often in modern residences, the most abundant fire suppressant is chlorinated water 103, such as it is found in residential swimming pools, and drinking water as found in the public water supply. The proximity of residential properties to ponds 110, lakes, streams and open bodies of water allows the system to tap them as a source of fire suppressant that can be used to suppress fires. Dedicated storage tanks and cisterns may be used to store a variety of fire suppressants other than water.

The pump 102 impels the siphoned fire suppressant 103 through one or more pipe conduit circuits 104 and 105, deployed in a variety of strategic areas, as they are well know to a person skilled in the art, in and around the premises.

In a preferred embodiment a pipe conduit circuit 104 is depicted deployed partially on the premise's perimeter fence 106. A second pipe conduit circuit 105, in the same embodiment or an alternative embodiment, is deployed on a roof edge of a premise's building 108, on the area which may normally host the roof gutters, and culminate in a battery of nozzles 109. The choice of the location of the pipe conduit circuit depends on a myriad of factors such as, for example and without limitation, the distance, elevation, and areas of coverage of the fire suppressant nozzles, the premise's terrain, the dimension of the pump, etc.

The pipe conduit circuit 104 terminates on one or more batteries of nozzles 107 dimensioned to contain one or more fire extinguishing nozzles capable of dispersing the fire suppressant to a wide area of coverage.

Even when a swimming pool is available, the proximity of a pond 110, lake, or other body of water may justify to use the water contained therein 110 as a back up source and use a separate pump to siphon the fire suppressant 110 an impel it through a pipe conduit that may be optionally connected to and existing pipe circuit, such as 104.

The determination of a fire condition by the fire condition detector 101 triggers one or more audiovisual alarms 113 to alert the building's 108 occupants of the impending fire. Additionally the alarm 113 is connected through wired or wireless means to a communications network such that it can contact and report the detected fire to the local fire department, to the premise's owners, and to other authorities.

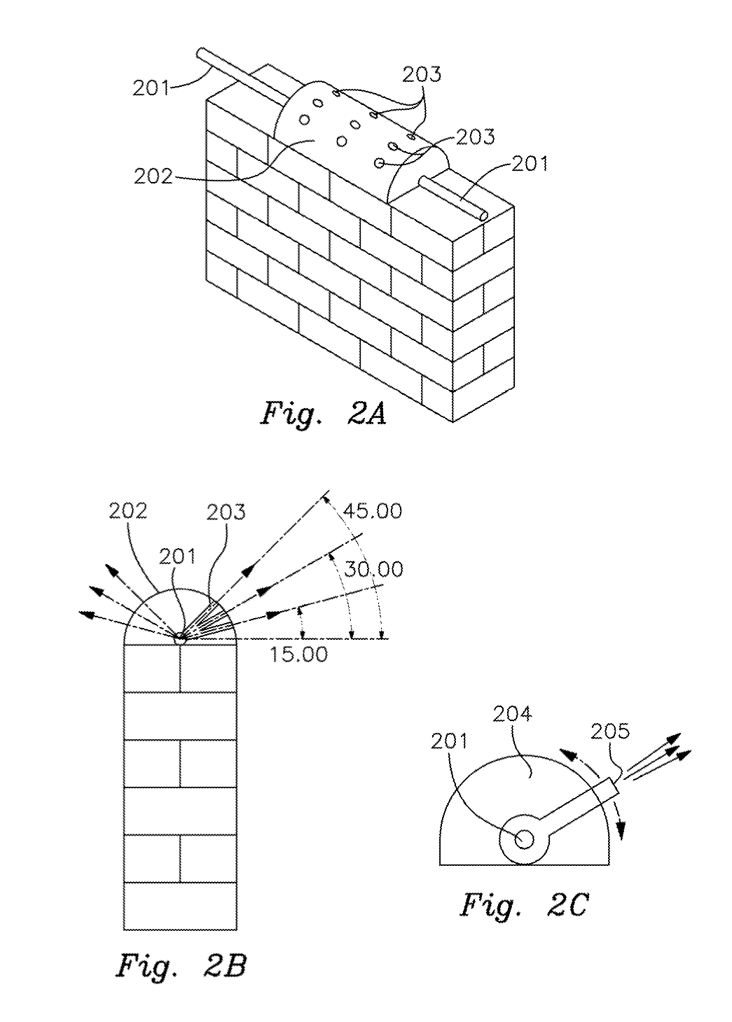

FIG. 2A depicts a particular embodiment of the invention. The pipe conduit circuit 201 carries the fire suppressant to one or more batteries of nozzles 202. The batteries of nozzles 202 containing one or more nozzles 203 positioned at one of various discrete fixed angles, such as 0°, 15°, 30°, and 45°, such that the fire suppressant may be impelled to cover short, medium, long, and longest range of coverage.

FIG. 28 shows is a detail of the internal disposition of the inventive battery of nozzles at fixed angles. A plurality of nozzles 203 are disposed at discreet angles, such as 15°, 30°, and 45°, and each nozzle is communicatively connected to the pipe conduit circuit 201 that carries the fire suppressant material. While not anticipated, there is nothing in the invention to preclude the disposition of nozzles at angles below the horizon such that fires proximate to the fence may be suppressed.

FIG. 2C shows is a detail of the internal disposition of the inventive battery of nozzles that may be positioned a variety of angles by being rotated over the transversal axis. Each battery of nozzles 204, may contain one or more nozzles 205 that may be rotationally positioned at any angle, on a continuous or discrete fashion, such that an impeding fire may be attacked with particularity and achieve a faster suppression result. The suppression position of the nozzles may be determined by a computer activated device, not shown, solely or in conjunction with other systems.

While the main invention is designed primarily to extinguish impending fires in and around the curtilage of the premises, including the exterior of any building contained therein, the aggregate deployment of more that one residential fire protection system can be used to strategically fight wildfires in a collective approach.

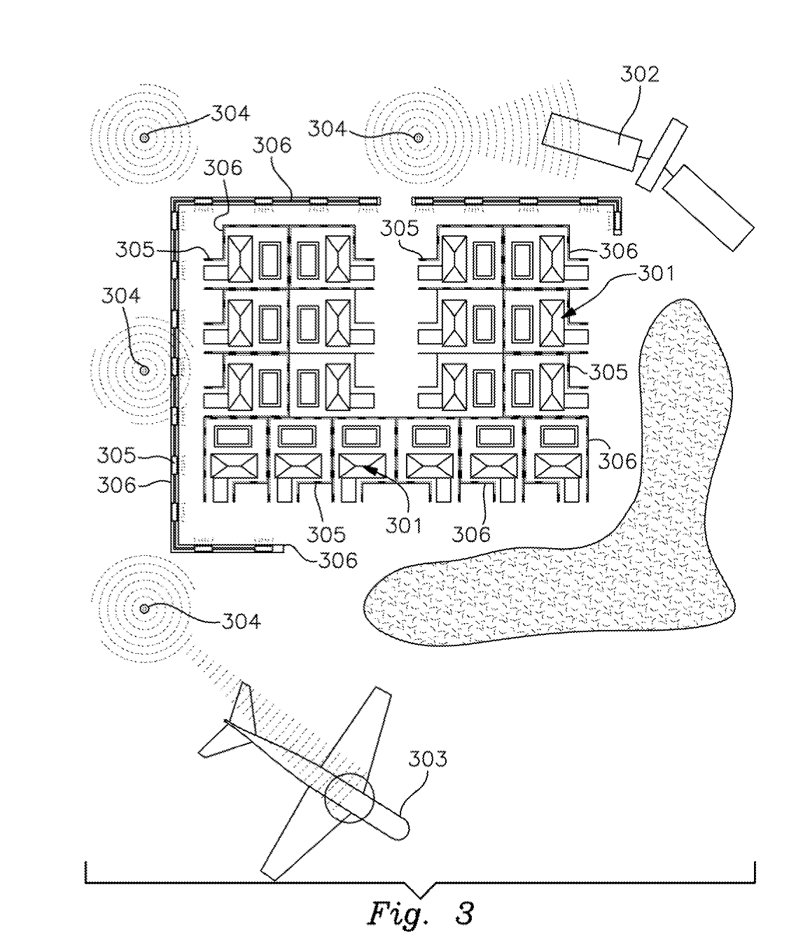

FIG. 3 depicts a preferred implementation of a zonal fire detection, protection, and suppression system. A plurality of properties 301, each with an installed residential fire protection system, may be used independently or collectively to combat a zonal wildfire, or a threat of it.

Often when a wildfire gets started it is difficult to predict to where it will expand. Prevailing winds, the amount of combustible material on its path, humidity levels, and terrain topography, amongst other factors, will contribute to determine the path of a wildfire. In addition to meteorological reports and measurements, an instant map of the wildfire may help to combat it. Satellite surveillance 302, remotely piloted unmanned vehicles 303 conducting aerial surveillance, or ground sensors 304 may provide firefighter authorities with a map of the wildfire. Since the residential fire protection system may be equipped with a remote activation control, the fire management could involve the activation of one or more residential fire protection systems to douse an impending wild fire or create a wildfire barrier by soaking the surrounding areas fire suppressant.

For example and without limitation, an impending fire may be fought activating the batteries of nozzles 305 installed in one or more properties that face the fire or on a barrier that surrounds a plurality of adjacent properties. Similarly a fire barrier may be created by activating other batteries of nozzles 306 that point to the desired area to be protected, including the premise's buildings.

What I claim is;

1. An outdoors residential fire detection, protection, and suppression system, the system comprising:
at least one fire suppressant storage reservoir containing a fire suppressant;
at least one pump connectively coupled to the at least one fire suppressant storage reservoir;
at least one pipe conduit circuit connectively coupled to the at least one pump;
at least one battery of nozzles connectively coupled to the at least one pipe conduit circuit, each of the at least one battery of nozzles comprising at least one fire extinguishing nozzle capable of dispersing the fire suppressant;
at least one audiovisual fire alarm; and
at least one fire condition detector with the capability to detect a fire condition, activate the at least one audiovisual fire alarm, and activate the at least one pump to siphon out the fire suppressant from the at least one fire suppressant storage reservoir and convey it through the at least one pipe conduit circuit to the at least one battery of nozzles and disperse it through the at least one fire extinguishing nozzle over the fire condition such that it is extinguished or over an adjacent area drenching it such that it creates a fire barrier.

2. The outdoors residential fire detection, protection, and suppression system of claim 1, wherein the at least one fire suppressant storage reservoir is one selected from a group comprising of a lake, a safer stream, an open body of water, a swimming pool, a storage tank, a cistern, a water well, and a public supply of water.

3. The outdoors residential fire detection, protection, and suppression system of claim 1, wherein the at least one pump is operated by an energy source selected from a group consisting of an independent electrical storage device, an electricity generator, and a mechanical motor.

4. The outdoors residential fire detection, protection, and suppression system of claim 1, wherein the at least one pipe conduit circuit is disposed and incorporated at least partially into a premise's perimeter fence.

5. The outdoors residential fire detection, protection, and suppression system of claim 1, wherein the at least one pipe conduit circuit is disposed and incorporated at least partially into a roof gutters of a premise's buildings.

6. The outdoors residential fire detection, protection, and suppression system of claim 1, wherein the at least one battery of nozzles comprises a plurality of fire extinguishing nozzles disposed at fixed discrete angles.

7. The outdoors residential fire detection, protection, and suppression system of claim 1, wherein the at least one battery of nozzles comprises at least one fire extinguishing nozzle capable of being rotationally positioned at any angle.

8. The outdoors residential fire detection, protection, and suppression system of claim i, wherein the at least one fire condition detector is capable of identifying a fire condition, determining the location of the fire condition, determining the distance of the fire condition from the at least one battery of nozzles, and activating the audiovisual fire alarm.

9. The outdoors residential fire detection, protection, and suppression system of claim 1, wherein the audiovisual fire alarm is capable of activating at least one alarm selected from a group consisting of a sound fire alarm, a visual alarm, and dialing at least one telephone number to report a fire emergency.

10. A zonal fire detection, protection, and suppression system, the system comprising:
at least one zonal fire condition detector; and
at least one outdoors residential, fire detection, protection, and suppression system, communicatively connected to and capable of being activated individually or collectively by the at least one zonal fire condition detector, the system comprising::
at least one fire suppressant storage reservoir containing a fire suppressant;
at least one pump connectively coupled to the at least one fire suppressant storage reservoir;
at least one pipe conduit circuit connectively coupled to the at least one pump;
at least one battery of nozzles connectively coupled to the at least one pipe conduit circuit, each of the at least one battery of nozzles comprising at least one fire extinguishing nozzle capable oh dispersing the fire suppressant;
at least one audiovisual fire alarm; and
at least one fire condition detector with the capability to detect a fire condition, activate the at least one audiovisual fire alarm, and activate the at least one pump to siphon out the fire suppressant from the at least one fire suppressant storage reservoir and convey it through the at least one pipe conduit circuit to the at least one battery of nozzles and disperse it through the at least one fire extinguishing nozzle over the fire condition such that it is extinguished or over an adjacent area drenching it such that it creates a fire barrier.

11. The zonal fire detection, protection, and suppression system of claim 10, wherein the at least one zonal fire condition detector is one selected from a group consisting of a fire detection satellite, a flying fire detection device, a ground based network of fire detection devices, a fire department instruction, a preprogrammed fire prevention activation, and a manual activation.

12. The zonal fire detection, protection, and suppression system of claim 10, wherein the at least one fire suppressant storage reservoir is one selected from a group comprising of a lake, a water stream, an open body of water, a swimming pool, a storage tank, a cistern, a water well, and a public supply of water.

13. The zonal fire detection, protection, and suppression system of claim 10, wherein the at least one pump is operated by an energy source selected from a group consisting of an independent electrical storage device, an electricity generator, and a mechanical motor.

14. The zonal fire detection, protection, and suppression system of claim 10, wherein the at least one pipe conduit circuit is disposed and incorporated at least partially into a premise's perimeter fence.

15. The zonal fire detection, protection, and suppression system of claim 10, wherein the at least one pipe conduit circuit is disposed and incorporated at least partially into a roof gutters of a premise's buildings.

16. The zonal fire detection, protection, and suppression system of claim 10, wherein the at least one battery of nozzles comprises a plurality of fire extinguishing nozzles disposed at fixed angles from 0° to 180° with respect to the horizon.

17. The zonal fire detection, protection, and suppression system of claim 10, wherein the at least one battery of nozzles comprises at least one fire extinguishing nozzle capable of being rotationally positioned at any angle from 0° to 180° with respect to the horizon.

18. The zonal fire detection, protection, and suppression system of claim 10, wherein the at least one fire condition detector is capable of identifying a fire condition, determining the location of the fire condition, determining the distance of the fire condition from the at least one battery of nozzles, and activating the audiovisual fire alarm.

19. The zonal fire detection, protection, and suppression system of claim 10, wherein the audiovisual fire alarm is capable of activating at least one alarm selected from a group consisting of a sound fire alarm, a visual alarm, and dialing at least one telephone number to report a fire emergency.

20. A zonal fire detection, protection, and suppression method, the method comprising:
utilizing at least one zonal fire condition detector;
detecting a potential or actual zonal fire condition;
determining which one of at least one outdoors residential fire detection, protection, and suppression system is proximate to the potential or actual zonal fire condition;
activating the at least one outdoors residential fire detection, protection, and suppression system such that at least one pump, connectively coupled to the at least one fire suppressant storage reservoir containing a fire suppressant, siphons out the fire suppressant and conveys it through at least one pipe conduit circuit to at least one battery of nozzles, comprising at least one fire extinguishing nozzle, and disperses the fire suppressant over the zonal fire condition or over an adjacent area drenching it such that it creates a fire barrier; and
activating at least one audiovisual fire alarm.

21. The zonal fire detection, protection, and suppression method of claim 20, wherein the at least one zonal fire condition detector is one selected from a group consisting of a fire detection satellite, a flying fire detection device, a ground based network of fire detection devices, a fire department instruction, a preprogrammed fire prevention activation, and a manual activation.

22. The zonal fire detection, protection, and suppression method of claim 20, wherein the at least one fire suppressant storage reservoir is one selected from a group comprising of a lake, a water stream, an open body of water, a swimming pool, a storage tank, a cistern, a water well, and a public supply of water.

23. The zonal fire detection, protection, and suppression method of claim 20, wherein the at least one pump is operated by an energy source selected from a group consisting of an independent electrical storage device, an electricity generator, and a mechanical motor.

24. The zonal fire detection, protection, and suppression method of claim 20, wherein the at least one pipe conduit circuit is disposed and incorporated at least partially into a premise's perimeter fence.

25. The zonal fire detection, protection, and suppression method of claim 20, wherein the at least one pipe conduit circuit is disposed and incorporated at least partially into a roof gutters of a premise's buildings.

26. The zonal fire detection, protection, and suppression method of claim 20, wherein the at least one battery of nozzles comprises a plurality of fire extinguishing nozzles disposed at fixed angles from 0° to 180° with respect to the horizon.

27. The zonal fire detection, protection, and suppression method of claim 20, wherein the at least one battery of nozzles comprises at least one fire extinguishing nozzle capable of being rotationally positioned at any angle from 0° to 180° with respect to the horizon.

28. The zonal fire detection, protection, and suppression method of claim 20, wherein the at least one fire condition detector is capable of identifying a fire condition, determining the location of the fire condition, determining the distance of the fire condition from the at least one battery of nozzles, and activating the audiovisual fire alarm.

29. The zonal fire detection, protection, and suppression method of claim 20, wherein the audiovisual fire alarm is capable of activating at least one alarm selected from a group consisting of a sound a fire alarm, a visual alarm, and dialing at least one telephone number to report a fire emergency.

30. An outdoors residential fire detection, protection, and suppression method, the method comprising:
providing at least one fire suppressant storage reservoir containing a fire suppressant;
providing at least one pump connectively coupled to the at least one fire suppressant storage reservoir;
providing at least one pipe conduit circuit connectively coupled to the at least one pump;
providing at least one battery of nozzles connectively coupled to the at least one pipe conduit circuit, each of the at least one battery of nozzles comprising at least one fire extinguishing nozzle capable of dispersing the fire suppressant;
providing at least one audiovisual fire alarm;
providing at least one fire condition detector;
activating the at least one fire condition detector;
detecting a fire condition;
activating the at least one audiovisual fire alarm;
activating the at least one pump to siphon out the fire suppressant from the at least one fire suppressant storage reservoir;
conveying the fire suppressant through the at least one pipe conduit circuit to the at least one battery of nozzles; and
dispersing the fire suppressant through the at least one fire extinguishing nozzle over the fire condition such that it is extinguished or over an adjacent area drenching it such that it creates a fire barrier.

31. The outdoors residential fire detection, protection, and suppression method of claim 30, wherein the at least one fire suppressant storage reservoir is one selected from a group comprising of a lake, a water stream, an open body of water, a swimming pool, a storage tank, a cistern, a water well, and a public supply of water.

32. The outdoors residential fire detection, protection, and suppression method of claim 30, wherein the at least one pump is operated by an energy source selected from a group consisting of an independent electrical storage device, an electricity generator, and a mechanical motor.

33. The outdoors residential fire detection, protection, and suppression method of claim 30, wherein the at least one pipe conduit circuit is disposed and incorporated at least partially into a premise's perimeter fence.

34. The outdoors residential fire detection, protection, and suppression method of claim 30, wherein the at least one pipe conduit circuit is disposed and incorporated at least partially into a roof gutters of a premise's buildings.

35. The outdoors residential fire detection, protection, and suppression method of claim 30, wherein the at least one battery of nozzles comprises a plurality of fire extinguishing nozzles disposed at fixed angles from 0° to 180° with respect to the horizon.

36. The outdoors residential fire detection, protection, and suppression method of claim 30, wherein the at least one battery of nozzles comprises at least one fire extinguishing nozzle capable of being rotationally positioned at any angle from 0° to 180° with respect to the horizon.

37. The outdoors residential fire detection, protection, and suppression method of claim 30, wherein the at least one fire condition detector is capable of identifying a fire condition, determining the location of the fire condition, determining the distance of the fire condition from the at least one battery of nozzles, and activating the audiovisual fire alarm.

38. The outdoors residential fire detection, protection, and suppression method of claim 30, wherein the audiovisual fire alarm is capable of activating at least one alarm selected from a group consisting of a sound a fire alarm, a visual alarm, and dialing at least one telephone number to report a fire emergency.
